(19) United States
(12) Patent Application Publication
(10) Pub. No.: US 2014/0025860 A1
(43) Pub. Date: Jan. 23, 2014

(54) INFORMATION APPARATUS, METHOD FOR SWITCHING SCREEN, AND COMPUTER-READABLE RECORDING MEDIUM HAVING STORED THEREIN SCREEN SWITCH PROGRAM

(71) Applicant: FUJITSU LIMITED, Kawasaki-shi (JP)

(72) Inventors: Yasushi HARA, Yokohama (JP); Masatomo YASAKI, Kako (JP); Katsumi OTSUKA, Kawasaki (JP)

(73) Assignee: FUJITSU LIMITED, Kawasaki-shi (JP)

(21) Appl. No.: 14/031,623

(22) Filed: Sep. 19, 2013

Related U.S. Application Data
(63) Continuation of application No. PCT/JP2011/056840, filed on Mar. 22, 2011.

(51) Int. Cl. G06F 13/40

(52) U.S. Cl. CPC G06F 13/4022
USPC 710/316

(57) ABSTRACT

The information apparatus runs a first operating system and a second operating system in parallel with each other thereon and includes a monitor, a memory, and a switch. The memory stores first screen data generated by a first application operating on the first operating system and second screen data generated by a second application operating on the second operating system in association with each other. The switch switches, when screen data to be displayed on the monitor is to be switched from screen data generated by the first application to screen data generated by the second application and when screen data having been displayed on the monitor before the switching is the first screen data, the first screen data to the second screen data stored in the memory in association with the first screen data.

### CROSS-REFERENCE TO RELATED APPLICATION

This application is a continuation application of International Application No. PCT/JP2011/056840, filed on Mar. 22, 2011, and designated the U.S., the entire contents of which are incorporated herein by reference.

### FIELD

The embodiment discussed herein is a technique of switching a screen.

### BACKGROUND

In accordance with recent improvement in throughput of an information apparatus such as an incorporated device and an information terminal (e.g., a smartphone), a virtual machine technique has come to be mounted onto the information apparatus. The virtual machine technique allows a single information apparatus to run multiple OSs (operating systems) thereon. Applications operating on each OS exclusively switch and display a screen such as an operation screen or a setting screen on the monitor of the information apparatus.

[Patent Literature 1] Japanese Laid-open Patent Publication No. 2002-318699

In a conventional technique, switching an OS to be displayed on the monitor displays the top menu screen or the screen previously displayed on the monitor. For the above, if the user wishes to continue a setting operation that have been made on the OS before the switch, the user moves to the screen of the OS after the switch to a desired screen by him/her self.

### SUMMARY

The information apparatus of an aspect of the technique disclosed herein runs a first operating system and a second operating system in parallel with each other thereon. The information apparatus includes a monitor, a memory that stores first screen data generated by a first application operating on the first operating system and second screen data generated by a second application operating on the second operating system in association with each other, and a switch. The switch switches, when screen data to be displayed on the monitor is to be switched from screen data generated by the first application to screen data generated by the second application and when screen data having been displayed on the monitor before the switching is the first screen data, the first screen data to the second screen data stored in the memory in association with the first screen data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating the entire configuration of an exemplary information apparatus according to a first embodiment;

FIG. 2 is a diagram illustrating a layer structure of screens of an OS#1;

FIG. 3 is a diagram illustrating an association table;

FIG. 4 is a diagram illustrating a layer structure of screens of an OS#2;

FIG. 5 is a flow diagram denoting a succession of procedural steps of switching notification;

FIG. 6 is a flow diagram denoting a succession of procedural steps of screen information obtaining;

FIG. 7 is a flow diagram denoting a succession of procedural steps of screen switching;

FIG. 8 is a diagram illustrating a succession of specific procedural steps performed in the information apparatus in the first embodiment;

FIG. 9 is diagram illustrating an association table in an information apparatus that includes three guest OSs;

FIG. 10 is a diagram illustrating an association table having records set by the manufacturer and records arbitrarily set by the user;

FIG. 11 is a diagram illustrating a returning route data table of OS#1

FIG. 12 is a block diagram schematically illustrating the entire configuration of an information apparatus further including a returning route data table; and

FIG. 13 is a diagram illustrating an example of hardware configuration of an information apparatus.

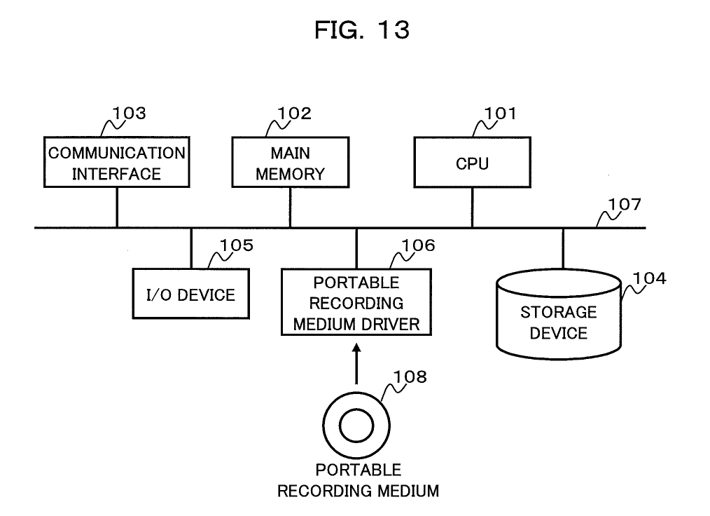

### DESCRIPTION OF EMBODIMENTS

Hereinafter, a first embodiment of the present invention will now be described with reference to accompanying drawings.

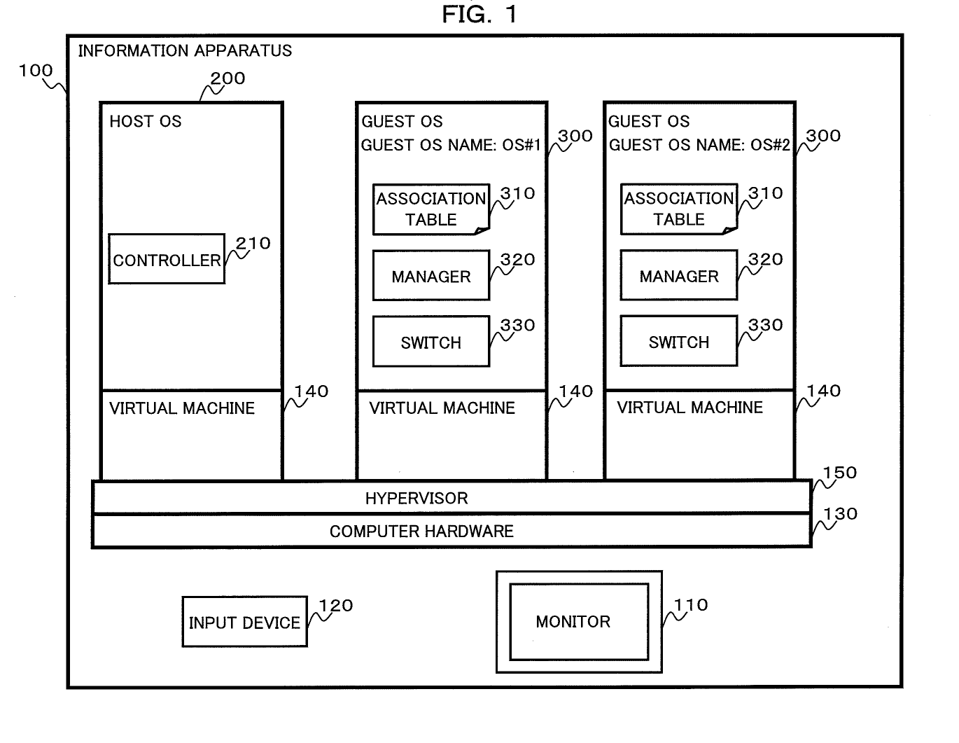

FIG. 1 is a diagram illustrating an example of an information apparatus 100 according to the first embodiment.

The information apparatus 100 includes a monitor 110 such as a Liquid Crystal Display (LCD), an input device 120, a computer hardware 130 on which software operates. A hypervisor 150 operates on the computer hardware 130 and thereby achieves virtual machines 140 each serving as a virtual computer. On one of the virtual machines 140 achieved by the hypervisor 150, a host OS 200 operates and on each of the remaining virtual machines 140, a guest OS 300 operates. The host OS 200 manages the guest OSs 300. The first embodiment assumes that two guest OSs 300 of OS#1 and OS# operate on the respective virtual machines 140. Examples of the guest OS 300 are Android (registered trademark) and Symbian (registered trademark) OS.

An input device 120 is an input environment that inputs operation and instruction on the information apparatus 100 from the user. Examples of the input device 120 are a button and a touch panel. Furthermore, such a button also functions as a switching button to switch the operating system (hereinafter also called OS).

Each guest OS 300 includes multiple screens (hereinafter also called application screens) output from one or more applications operate on the guest OS 300. Being output to a frame buffer of the virtual machine 140 on which a guest OS 300 operates, one of the application screens of the guest OS 300 is regarded as a screen to be output of the guest OS 300. Further, when one of the screens to be output of the respective guest OSs 300 is output to the monitor 110, the application screen is exclusively displayed on the monitor 110.

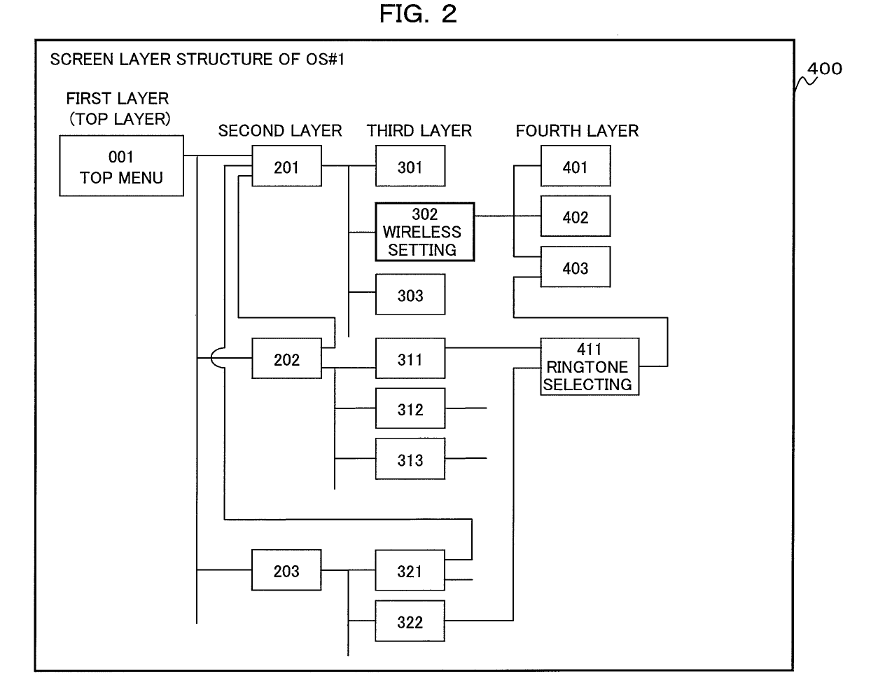

The application screens of each guest OS 300 are layered into a screen layer structure 400 illustrated in FIG. 2 in the guest OS 300. The screens to be output of each guest OS 300 changes from one to another on the basis of the layered structure of the application screens. Each application screen is provided with a screen ID (Identification) serving as an identifier for specifying the application screen in the corresponding guest OS 300. In the example of FIG. 2, the application screen for wireless setting has an screen ID “302”.

Each guest OS 300 includes an association table 310 that can be referred by the guest OS 300.

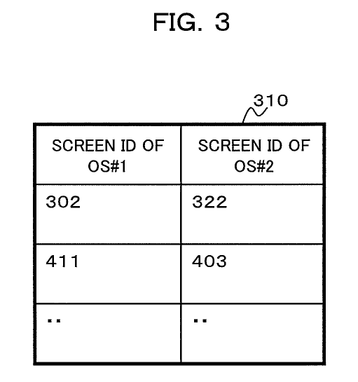

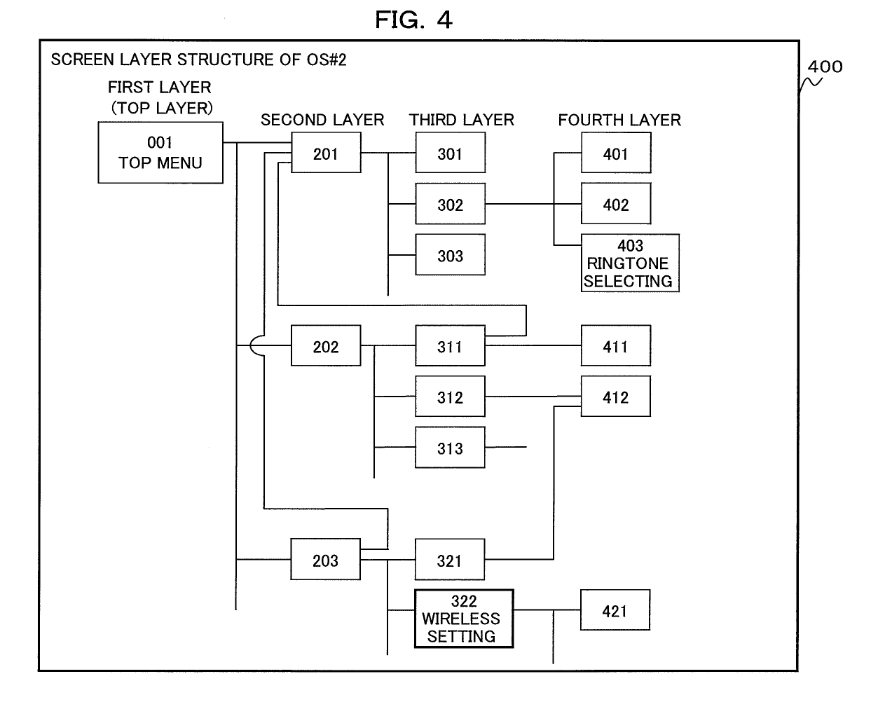

The association table 310 is a table that sets the association between application screens of the respective guest OSs 300. Specifically as illustrated in FIG. 3, the association table 310 includes records each screen IDs of the application screens of the guest OSs 300 with each other. For example, in cases where the OS#1 and the OS#2 have layer structures of application screens of FIGS. 2 and 4, respectively, the association table 310 illustrated in FIG. 3 associates wireless setting screens of the respective guest OSs 300 with each other, and similarly associates ringtone selecting screens of the respective OSs 300 with each other. The association table 310 is set by, for example, the manufacturer of the information apparatus 100, and is stored in the memory, such as a non-volatile memory, included in the information apparatus 100. The association table 310 functions as one example of a table.

The host OS 200 includes a controller 210, and each guest OS 300 includes a manager 320 and a switch 330.

The controller 210 receives a relevant switch instruction that instructs to switch the guest OS 300 to be displayed, that is, an instruction to switch the current application screen being currently displayed to an application screen relevant to the current application screen, via the input device 120 from the user. For example, when the user depresses and holds the button of the input device 120 or the touch panel for one second and longer, the controller 210 receives a relevant switch instruction. Upon receipt of the relevant switch instruction, the controller 210 sends the manager 320 of the guest OS 300 serving as the switching source an inquiry about the screen ID of the current application screen being currently displayed. Then, the controller 210 transmits the screen ID received in response to the inquiry to the switch 330 of the guest OS 300 serving as the switching destination.

Furthermore, the controller 210 receives a normal switch instruction that instructs to switch the guest OS 300 to be displayed, that is, an instruction to switch the current application screen being currently displayed to an application screen not being relevant to the current application screen, via the input device 120 from the user. For example, when the user presses the button of the input device 120 and the touch panel and releases the button of the input device 120 or the touch panel within a time period shorter than one second, the controller 210 receives a normal switch instruction. Upon receipt of the normal switch instruction, the controller 210 transmits, for example, NULL for a screen ID to the switch 330 of the guest OS 300 of the switching destination.

Upon receipt of the inquiry about the screen ID from the controller 210, the manager 320 replies to the controller 210 with the screen ID of the application screen being currently displayed.

When the screen ID received from the controller 210 is NULL, the switch 330 switches the current screen being currently displayed on the monitor 110 to the top menu screen or a screen previously displayed. Switching to the top menu screen or a screen previously displayed is set by, for example, the user in advance.

When the screen ID received from the controller 210 is not NULL, the switch 330 refers to the association table 310 and switches the screen being currently displayed on the monitor 110 to an application screen specified by the guest OS 300 of the switching destination and the received screen ID.

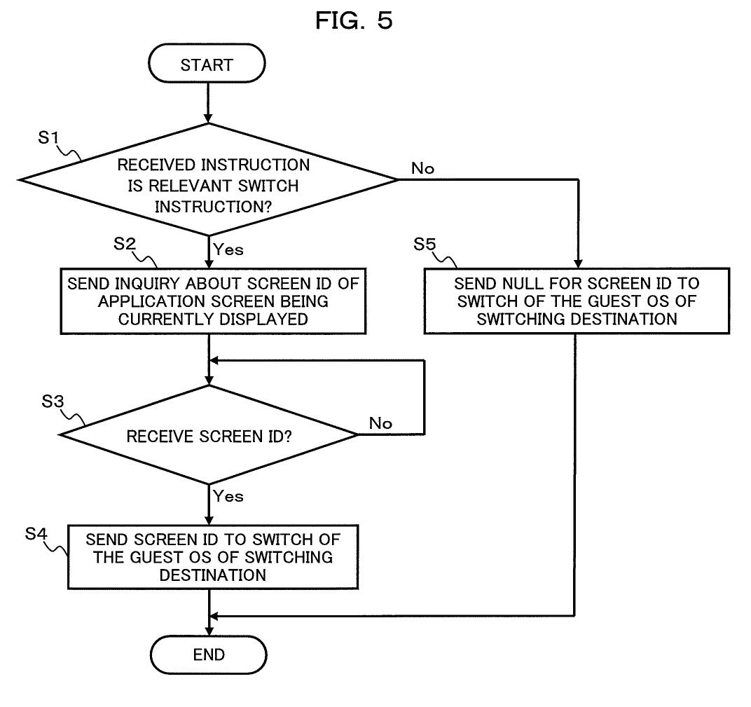

FIG. 5 is a flow diagram a succession of procedural steps of switching notification performed when the controller 210 receives a relevant switch instruction or a normal switch instruction from the user via the input device 120.

In step 1 (abbreviated to “S1” in the drawing; successive steps are the same), the controller 210 determines whether or not the instruction received therein is a relevant switch instruction. When the received switch is a relevant switch instruction, the controller 210 moves the procedure to step 2 (Yes route). Conversely, when the received switch is not a relevant switch instruction, the controller 210 moves the procedure to step 5 (No route).

In step 2, the controller 210 sends the manager 320 of the guest OS 300 of the switching source an inquiry about the screen ID of the application screen being currently displayed on the monitor 110.

In step 3, the controller 210 determines whether or not the controller 210 receives a screen ID from the manager 320 of the guest OS 300 of the switching source. When receiving the screen ID, the controller 210 moves the procedure to step 4 (Yes route). Conversely, when not receiving the screen ID, the controller 210 returns the procedure to step 3 (No route).

In step 4, the controller 210 determines the other guest OS 300 different from the guest OS 300 being the switching source to be the switching destination and sends the screen ID to the switch 330 of the guest OS 300 of the switching destination. For example, in cases where the guest OS 300 being the switching source is OS#1, the controller 210 sends the screen ID to the switch 330 of OS#2.

In step 5, the controller 210 determines the other guest OS 300 different from the guest OS 300 being the switching source to be the switching destination and sends NULL for a screen ID to the switch 330 of the guest OS 300 of the switching destination.

In the switching notification, upon receipt of a relevant switch instruction, the controller 210 sends the manager 320 of the guest OS 300 of the switching source an inquiry about the screen ID of the application screen being currently displayed. Then, the controller 210 transmits the screen ID notified in response to the inquiry to the switch 330 of the guest OS 300 of the switching destination. Upon receipt of a normal switch instruction, the controller 210 sends the switch 330 of the guest OS 300 of the switching destination NULL for the screen ID.

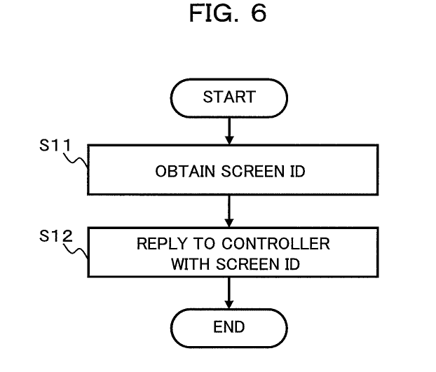

FIG. 6 is a flow diagram denoting a succession of procedural steps of screen information obtaining carried out by the manager 320 in response to receipt of an inquiry about the screen ID of the application screen being currently displayed on the monitor 110 from the controller 210.

In step 11, the manager 320 obtains the screen ID of the application screen being currently displayed, that is, the application screen set to be the output screen of the guest OS 300 that is the manager 320 itself belongs to, by means of a system call. The application screen being currently displayed is regarded as an example of a first screen.

In step 12, the manager 320 replies to the controller 210 with the screen ID.

In this screen information obtaining, the manager 320 replies to the controller 210 with the screen ID of the application screen being currently displayed on the monitor 110.

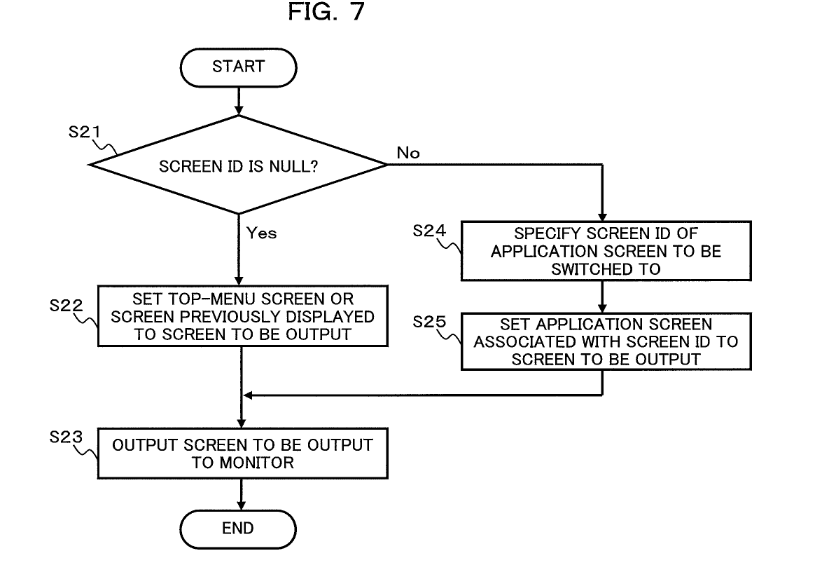

FIG. 7 is a flow diagram denoting a succession of procedural steps of screen switching carried out by the switch 330 upon receipt of a screen ID from the controller 210.

In step 21, the switch 330 determines whether the received screen ID is NULL. When the received screen ID is NULL, the switch 330 moves the procedure to step 22 (YES route). Conversely, when the received screen ID is not NULL, the switch 330 moves the procedure to step 24 (No route).

In step 22, the switch 330 sets the top-menu screen or a screen previously displayed to a screen to be output of the guest OS 300 that the switch 330 itself belongs to.

In step 23, the switch 330 outputs the screen to be output of the guest OS 300 that the switch 330 itself belongs to the monitor 110 and thereby the screen on the monitor 110 is switched.

In step 24, the switch 330 refers to the association table 310 and specifies the record using the guest OS 300 of the switching source and the received screen ID. The switch 330 extracts the screen ID of the guest OS 300 of the switching destination from the specified record.

In step 25, the switch 330 sets the application screen specified by the extracted screen ID to the screen to be output of the guest OS 300 that the switch 330 itself belongs to. The application screen specified by the extracted screen ID is regarded as an example of a second screen.

In this screen switching, in cases where the received screen ID is NULL, the switch 330 switches the current screen on the monitor 110 to the top menu screen or a display previously displayed. On the other hand, in cases where the received screen ID is not NULL, the switch 330 refers to the association table 310 and switches the screen on the monitor 110 to an application screen specified by the screen ID associated with the received screen ID.

Accordingly, when the guest OS 300 is switched to another guest OS 300 in response to a relevant switch instruction, the current application screen on the monitor 110 is switched to an application screen associated with the application screen displayed before the switching in referring to the association table 310. This eliminates the requirement of, after the switching, transition to an application screen associated with the application screen displayed before the switching, and consequently enhances the operability.

A specific embodiment carried out by the information apparatus 100 having the above configuration will now be detailed below.

The first embodiment assumes that the application screens of the OS#1 and OS#2 have layer structures of FIGS. 2 and 4, respectively, and the OS#1 and OS#2 has a common association table 310 of FIG. 3. The application screen being currently displayed on the monitor 110 is assumed to be the wireless setting screen having a screen ID “302” of the OS#1. When the button of the input device 120 is depressed and held, a relevant switch instruction is sent to the controller 210. When the button of the input device 120 is normally depressed, a normal instruction is sent to the controller 210.

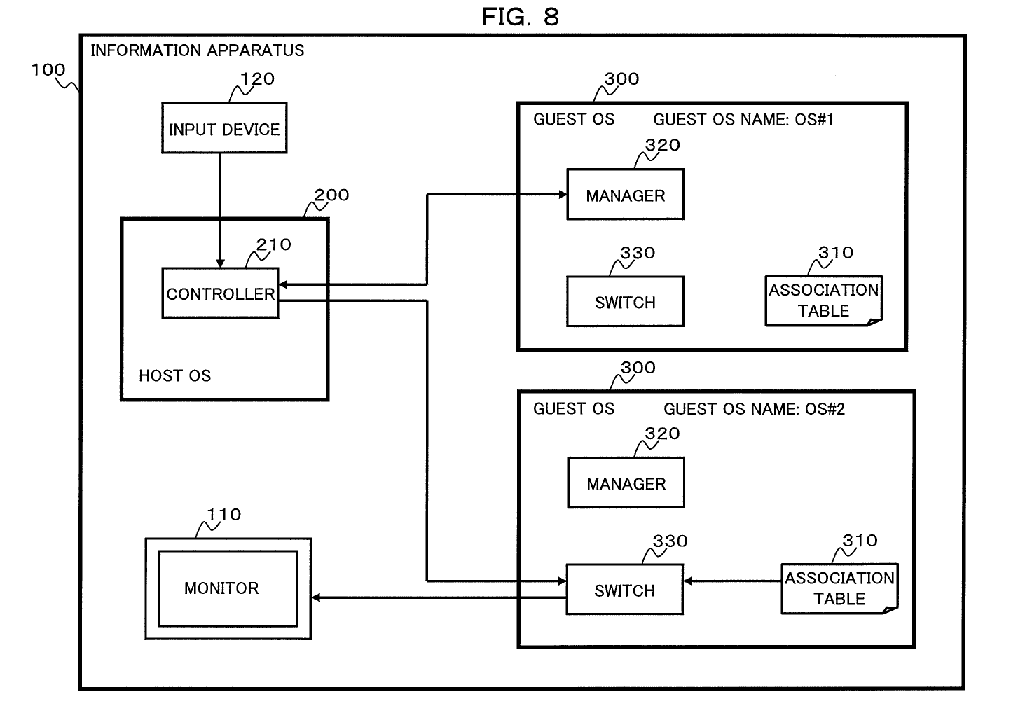

FIG. 8 illustrates a diagram illustrating a succession of procedural steps of the first embodiment.

The user that wishes to carry out relevant switch depresses and hold the button of the input device 120. In response to the depressing and holding the button of the input device 120, the controller 210 sends the manager 320 of the OS#1 serving as the guest OS 300 of the switching source an inquiry about a screen ID of the application screen being currently displayed on the monitor 110. The manager 320 of the OS#1 replies to the controller 210 with the screen ID “302” of the wireless setting screen being currently displayed. The controller 210 transmits the screen ID “302” to the switch 330 of the OS#2 serving as the guest OS 300 of the switching destination. The switch 330 of the OS#2 refers to the association table 310 and specifies the screen ID “322” of the OS#2 associated with the received screen ID “302”. The switch 330 of the OS#2 sets the wireless setting screen of the OS#2, the screen having a screen ID “322”, to be a screen to be output of the OS#2. Furthermore, the switch 330 of the OS#2 outputs the screen to be output screen of the OS#2 to the monitor 110 and thereby the current screen on the monitor 110 is switched to the wireless setting screen of the OS#2.

Alternatively, the user that wishes to carry out normal switching normally depresses the button of the input device 120. In response to the normal depressing of the button of the input device 120, the controller 210 sends the switch 330 of the OS#2 serving as the guest OS 300 the switching destination NULL for the screen ID. When the received screen ID is NULL, the switch 330 of the OS#2 sets the top menu screen of the OS#2, the screen having the screen ID “001”, to be a screen to be output of the OS#2. Furthermore, the switch 330 of the OS#2 outputs the screen to be output of the OS#2 to the monitor 110 and thereby the current screen on the monitor 110 is switched to the top menu screen of the OS#2.

In addition to the above first embodiment, the information apparatus 100 has an alternative embodiment as will be described below.

Part of or all of the controller 210, the managers 320, and the switches 330 may be included in the hypervisor 150. Besides, the association table 310 may be disposed in the hypervisor 150.

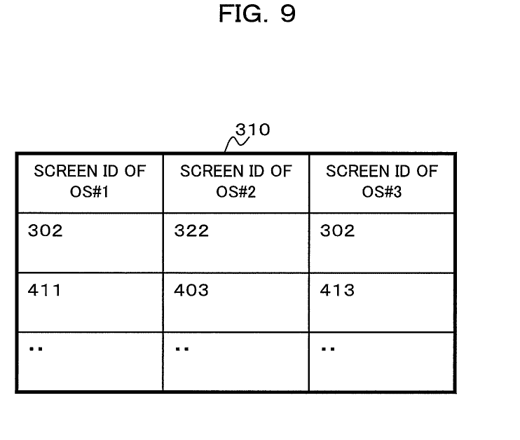

The information apparatus 100 may include three or more guest OSs 300. For example, the information apparatus 100 may include three guest OSs 300 of OS#1, OS#2, and OS#3. With this configuration, the guest OSs 300 are repeatedly switched to one after another in order of OS#1, OS#2, OS#3, OS#1, and . . . each time a switch instruction is input from the user. As illustrated in FIG. 9, the association table 310 when the information apparatus 100 includes three guest OSs 300 includes records each associating screen IDs of the three guest OSs 300 with one another. For example, the guest OS 300 serving as the switching source is the OS#2 and the application screen being currently displayed on the monitor 110 has a screen ID “403”, the application screen to be displayed next as a result of switching has a screen ID “413” of the OS#3. Then, in cases where an additional switch instruction is input, the application screen to be displayed as a result of the switching has a screen ID “411” of the OS#1.

When the screen ID of application screen being currently displayed on the monitor 110 does not appear in the association table 310 in the event of relevant switching, the application screen being currently displayed may be switched to the top menu screen or a screen previously displayed of the guest OS 300 serving as the switching destination.

In the event of normal switching, the current screen displayed on the monitor 110 may be switched to the application screen previously displayed by the guest OS 300 serving as the switching destination.

An association already defined in the association table 310 may be arbitrarily rewritten by the user. For this purpose, a tool to rewrite the association table 310 is incorporated into each guest OS 300.

In addition to records set by the manufacturer (hereinafter, such a record is referred to as a “manufacturer record”), the association table 310 may include records each representing association of application screens of the guest OSs 300 with one another, the records being arbitrarily settable by the user (hereinafter, such a record settable by the user is referred to as a “user record”). In switching a guest OS 300 displayed on the monitor 110, a user record is preferentially used over the corresponding manufacturer record.

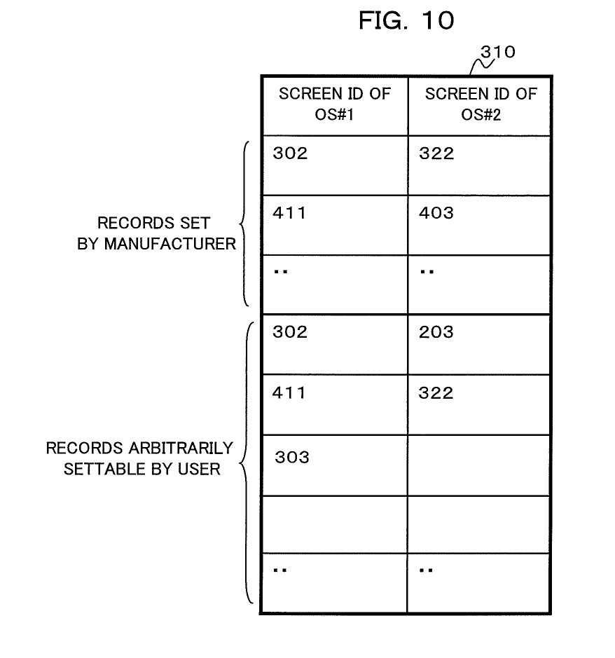

As illustrated in FIG. 10, an example of the association table 310 in this case includes, in sequence, manufacturer records and user records. User records in the association table 310 are blank before setting by the user. The user associates particular application screens of the respective guest OSs 300 with each other in the user records using screen IDs.

In the event of relevant switch, when a screen ID in a manufacturer record associated with the screen ID of the application screen being currently displayed is different from the screen ID of the corresponding user record associated with the same screen ID of the current application screen, the user record is preferentially used for the switching. In the event of relevant switch, when the association table 310 has no screen ID associated with the screen ID of the application screen being currently displayed, in other words, the associated screen ID is blank, the current application screen on the monitor 110 is to be switched to the top menu screen or a screen previously displayed of the guest OS 300 of the switching destination.

A region of the association table 310 that includes the manufacturer records is regarded as an example of a first region and a region of the association table 310 that includes the user records is regarded as an example of a second region.

Each guest OS 300 may include a transition history, which is the information representing chronological transition of output application screens of the guest OS 300. Specifically, a transition history records of transition from the top application screen (e.g., the top menu screen) to the application screen being the current output screen using screen IDs. Each time the output screen is changed due to user's operation, the guest OS 300 being displayed records the screen ID of the changed application screen into the transition history thereof. Tracing back the transition history allows the output screens to change from the current output screen to the top application screen in the reverse order of the transition (hereinafter referred to as “operation returning the output screens”).

For example, description will now be given, assuming that the OS#1 has the layer structure of application screens as illustrated in FIG. 2.

This example assumes that the operation made by the user sequentially changes the application screen of the screen ID “001” of the OS#1 to, in sequence, screens having screen IDs “202”, “311”, and “411” of the OS#1. In this case, the transition history of the OS#1 is “001-202-311-411”. After that, the user made an operation to return the output screens, the output screen of the OS#1 is returned from the application screen having a screen ID “411” to that having a screen ID “311” on the basis of the transition history of the OS#1. Further, when the user made another operation to return the output screens, the application screen having a screen ID “311” is returned to that having a screen ID “202” on the basis of the transition history of the OS#1.

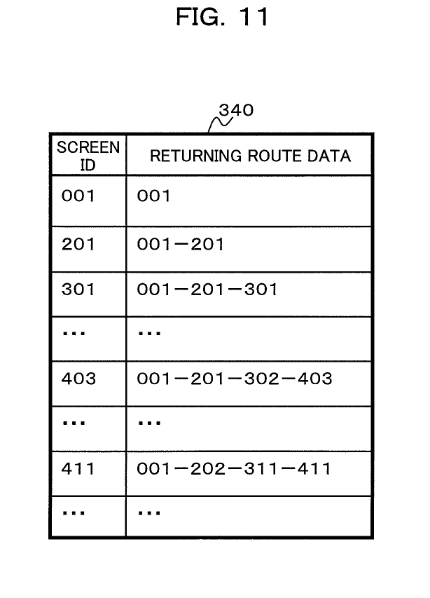

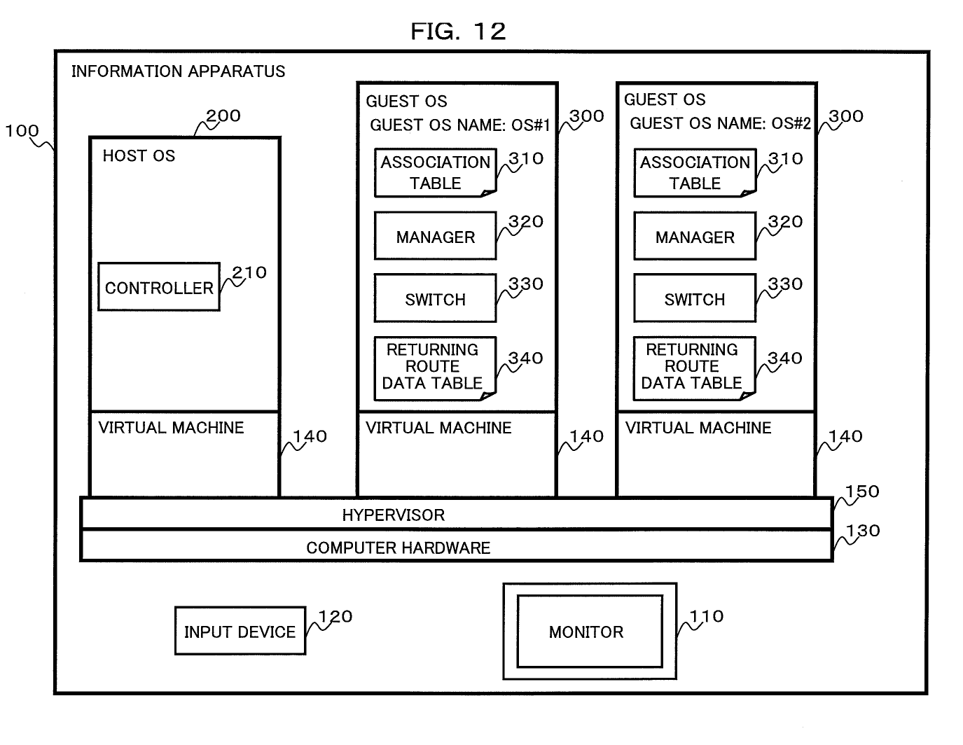

In cases where the first embodiment incorporates transition histories, the transition history of a guest OS 300 after relevant switch is unchanged from the previous display. For the above, return route data representing a return route of the output screens from the application screen being currently displayed to the top-layer application screen is defined in advance, and in the event of operation of returning application screens after relevant switch, the return route data is used instead of the transition history. Specifically, as denoted in FIG. 11, return route data is determined for each screen ID of the application screen and is set in a return route data table 340. As illustrated in FIG. 12, a return route data table 340 is provided to each guest OS 300. For example, each return route data table 340 is defined by the manufacturer of the information apparatus 100 and is stored in, for example, a memory such as a non-volatile memory included in the information apparatus 100.

For example, the OS#1 is assumed to have a layer structure of the application screens as illustrated in FIG. 2 and a return route data table 340 as illustrated in FIG. 11, and is further assumed to display an application screen having a screen ID “301” of OS#1 after relevant switch. When the user makes an operation to return the output screens of the OS#1 to the top menu screen, the return route data “001-201-301” of the screen ID “301” is used, so that the output screen returns in sequence, screen having screen IDs “301”, “201”, and “001”.

As illustrated in FIG. 100, the information apparatus 100 may further include hardware devices such as a Central Processing Unit (CPU) 101, a main memory 102, a communication interface 103, a storage device 104, an I/O device 105, and a portable recording medium driver 106. The respective hardware devices are mutually connected via a bus 107. The main memory 102 is accessed by the CPU 101 and is exemplified by a Random Access Memory (RAM). The communication interface 103 is a device to receive and send data via a network and is exemplified by a network card. The I/O device 105 inputs data into the information apparatus 100 and outputs data from the information apparatus 100, and is exemplified by a keyboard, a mouse, and/or a monitor. The portable recording medium driver 106 reads data from a portable recording medium 108 that stores therein data and that is exemplified by a computer-readable recording medium such as a CD-ROM and/or DVD-ROM. Examples of the portable recording medium driver 106 are a CD-ROM drive and a DVD-ROM drive. The portable recording medium 108 have been stored therein a screen switching program that achieves the above first embodiment. The screen switching program stored in the portable recording medium 108 is installed into a storage device 104 via the portable recording medium driver 106 by a known method. The CPU 101 loads the installed screen switching program into the main memory 102 and executes the loaded program to achieve the controller 210, the managers 320, and the switches 330. Alternatively, the screen switching program may be installed from a network into the storage device 104 via the communication interface 103

The disclosed technique enhances the operability in an information apparatus.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. An information apparatus that runs a first operating system and a second operating system in parallel with each other thereon, the apparatus comprising:
a monitor;
a memory that stores first screen data generated by a first application operating on the first operating system and second screen data generated by a second application operating on the second operating system in association with each other;
a switch that switches, when screen data to be displayed on the monitor is to be switched from screen data generated by the first application to screen data generated by the second application and when screen data having been displayed on the monitor before the switching is the first screen data, the first screen data to the second screen data stored in the memory in association with the first screen data.

2. The information apparatus according to claim 1, wherein:
the memory comprises a first region that stores the first screen data and the second screen data in association with each other, and a second region that stores screen data generated by each application operating on the first operating system and screen data generated by each application operating on the second operating system in association with each other, the association in the second region being arbitrarily determined by a user; and
when screen data associated with the first screen data in the first region is different from screen data associated with the first screen data in the second region, the switch refers to the second region and displays screen data associated with the first screen data in the second region on the monitor.

3. The information apparatus according to claim 1, wherein the association in the memory is arbitrarily rewritten.

4. The information apparatus according to claim 1, further comprising a switch button that switches between the first operating system and the second operating system,
the switch specifies, when the switch button is depressed for a predetermined time, the first screen data being currently displayed on the monitor.

5. A method for switching a screen in an information apparatus that comprises a monitor and a memory and that runs a first operating system and a second operating system in parallel with each other thereon, the method comprising:
storing, in the memory, first screen data generated by a first application operating on the first operating system and second screen data generated by a second application operating on the second operating system in association with each other; and
switching, when screen data to be displayed on the monitor is to be switched from screen data generated by the first application to screen data generated by the second application and when screen data having been displayed on the monitor before the switching is the first screen data, the first screen data to the second screen data stored in the memory in association with the first screen data.

6. A computer-readable recording medium having stored therein a screen switching program causing an information apparatus that comprises a monitor and a memory and that runs a first operating system and a second operating system in parallel with each other thereon to execute a process comprising:
when screen data to be displayed on the monitor is to be switched from screen data generated by a first application operating on the first operating system to screen data generated by a second application operating on the second operating system,
referring to the memory that stores screen data generated by the first application operating on the first operating system and second screen data generated by the second application operating on the second operating system in association with each other; and
switching ,when screen data having been displayed on the monitor before the switching is the first screen data, the first screen data to the second screen data stored in the memory in association with the first screen data.
